(19) United States
(12) Patent Application Publication
(10) Pub. No.: US 2013/0031577 A1
(43) Pub. Date: Jan. 31, 2013

(54) System and method for selling any audio or video advertising and recording the ad spot, collecting payment and delivering by email to broadcast media using software and applications utilized through computing or telecommunications devices

(71) Applicant: Christopher R. Pixley, Cape Coral, FL (US)

(72) Inventor: Christopher R. Pixley, Cape Coral, FL (US)

(21) Appl. No.: 13/190,426

(22) Filed: Jul. 25, 2011

(51) Int. Cl. H04N 7/10

(52) U.S. Cl. 725/32

(57) ABSTRACT

An online or otherwise server hosted software used by any type of electronic Media to offer Advertising minutes (ad spots) for sale to Advertisers who, in one session, selects the ad spot's duration, broadcast dates and times, uploads or writes and record the Ad Spot on the system which then invoices and collects payment by Credit Card or alternative means, whereupon an email containing an insertion order and other details along with the Sound/Video file is sent to the broadcasting Station for transmission.

### CROSS RELATED REFERENCES

This application claims priority to Provisional Patent Application No. 61/400,264 filed on Jul. 26, 2010.

### STATEMENT REGARDING FEDERALLY SPONSORED RESEARCH OR DEVELOPMENT

N/A

### BACKGROUND OF THE INVENTION

1. Field of the Invention

The present invention relates to system and method for Media to sell advertising and where required, the production of Advertising Spots (Ad Spots) in Audio and video formats over a network, in particular, the internet, for broadcast on Audio or Visual Media such as Radio & Television stations (internet or terrestrial), Pod-casters, Blog-casters and all other electronic media which offer advertising time for sale on the system.

2. Background and Prior Art

over the past few years, there has been a reduction of advertising spend by the larger businesses due to upheaval in the global economy and other factors, Concurrently, due to the massive development of digital technology, led by the vast expansion of Internet hosted Radio and Television stations and like content providers, there is a growing choice of media all thirsty for Advertising revenue.

To the small and medium enterprise (SME) Advertiser, with a small budget, the variables to be considered when choosing the most beneficial media on which to place advertising, is so complicated, that the process is usually best left to a professional agency.

Prior Art, is usually structured to sell Ad Spots to large media buyers, primarily through a bidding process involving large sums for each transaction, this invention is designed to simplify the process involved for both the Media and the small volume advertiser, as given a micro budget, many SME's are unable to access the traditional systems as the proportion of the budget spent on professional services, which include media selection, copy writing, voice overs and video shooting and editing, leaves very little for Ad Spot purchase.

Additionally, there is the issue of time critical messages. SMEs such as a local Used Car Dealer, need to promote the actual inventory of vehicles in stock, therefore the Used Car Dealer has to change his Ad Spot copy frequently as the inventory rotates off the lot. The cost of remaking the Ad Spot to promote new inventory precludes this type of SME from the electronic Media and divert them to printed publications, like Newspapers, where the message or photo can be changed at a very low cost.

Further, unlike national brands that need massive national proliferation of their advertising messages, with the attendant demographic and other measurements informing Media selection, SMEs usually sell their goods or services to their local geographic area, therefore removing the complexity of media selection

The prior Art, often provide computer based solutions to Ad Spot stowage and retrieval for sale and is competent in associating Ad Spots with media genre, program content, geographic and demographic conditionality. Additionally, Prior Art is most frequently installed on systems which serve media groups and Media Buyers that complete transactions in large quantities and high dollar value.

Another iteration of prior Art, is the hosting of multiple media outlets whom place Advertising inventory for sale on a bidding basis. Again, the complexity, volumes, lead time to order and produce an advertising message usually attendant with these processes, exceed the competence of the Ad Hoc SME Advertiser.

The current invention is designed to create and host a platform which afford the Media a new means of selling small volumes of Ad minutes to a new downstream marketplace, while at the same time providing, all the facilities from offer of Ad Spots through production and recording of Ad messages to collecting the funds and transmitting by email the finished transaction all in a single transaction with Advertisers.

### SUMMARY OF THE INVENTION

The deployment of this invention on the World Wide Web affords the system to become accessible by a global marketplace.

The principal function of this invention is to provide a platform for all Media, but in particular emerging media, such as Internet based broadcasters, podcasts, Blogs, etc giving these full control and authority to assign advertising minutes for sale to a downstream marketplace that had previously not identified with broadcast advertising.

Further, this invention, is designed to facilitate access by advertisers through participating Media's own Website, direct to that Media's account on the system as the only choice. Prior Art** exposes that referring Media's advertising customer to all other Media on their site. This feature forms a part of the Inventor's Claim.

Radically new with this invention also, is the built in Recording Studio, enabling an advertiser, in one session, to select advertising spots and dates for broadcast, write, produce and voice his or her own timed advertising message, receive an invoice, pay by Credit Card and Checkout with Ad Spots starting to run as early as tomorrow on an increasing and global choice of Media. This invention sends the completed, timed Message by email immediately after checkout to the selected Media.

Finally, given this inventions ability to generate small dollar vale transactions, it will take the place of salesmen who necessarily have to focus on large advertisers due to the cost of sales.

### DETAILED DESCRIPTION OF THE DRAWINGS

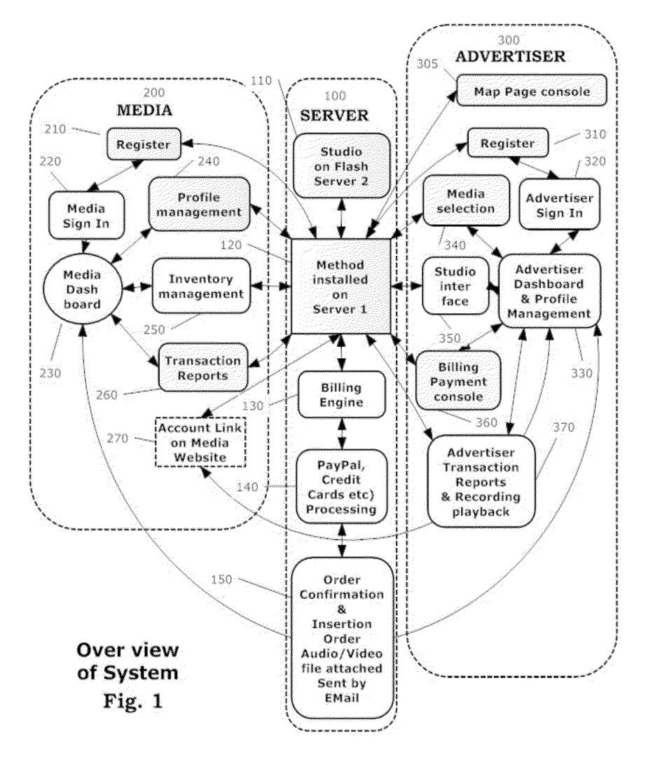

FIG. 1. Is an overview diagram of a system design for Media Stations 200 to register and assign Ad spots for sale and Advertiser 300 that register and purchase ad spots from the inventory provided by the Media Stations.

Further the system Servers 100 have a built in Recording Studio 110 to record timed advertisements voiced by the user, then convert these audio or Video files to the appropriate format for broadcast. Additionally, the system is designed to generate invoices 130, process Credit Cards 140. Finally the system will produce an insertion order and a transaction report and email these with the attached audio or video file to the selected Media and to the Advertiser. 150

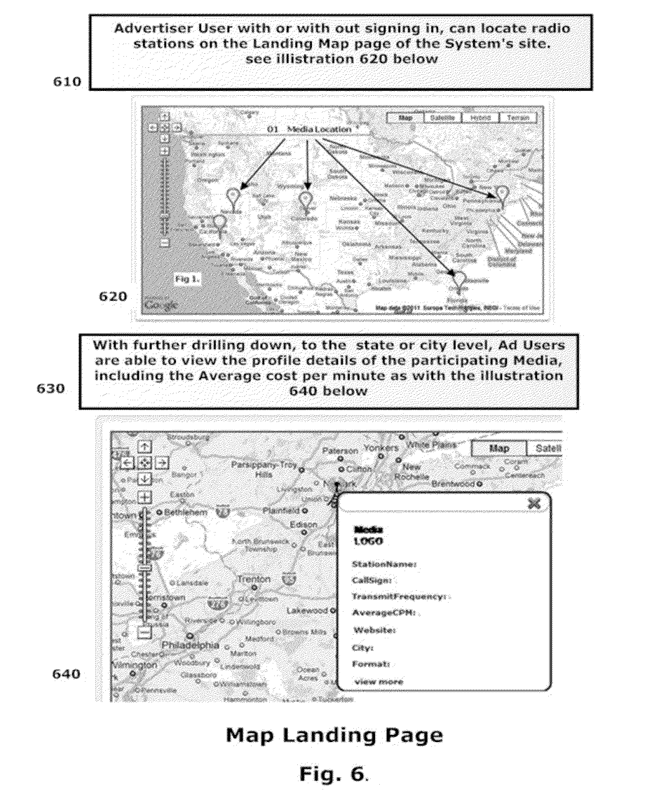

The Map Landing Page is accessible without signing in to an account. This feature, through the Map Page console, provides information regarding Media in an geographic location including Media identity, average cost per Minute, links to the Medias web site, whether the Media have minutes available for sale. See FIG. 6 for further Information on this feature.

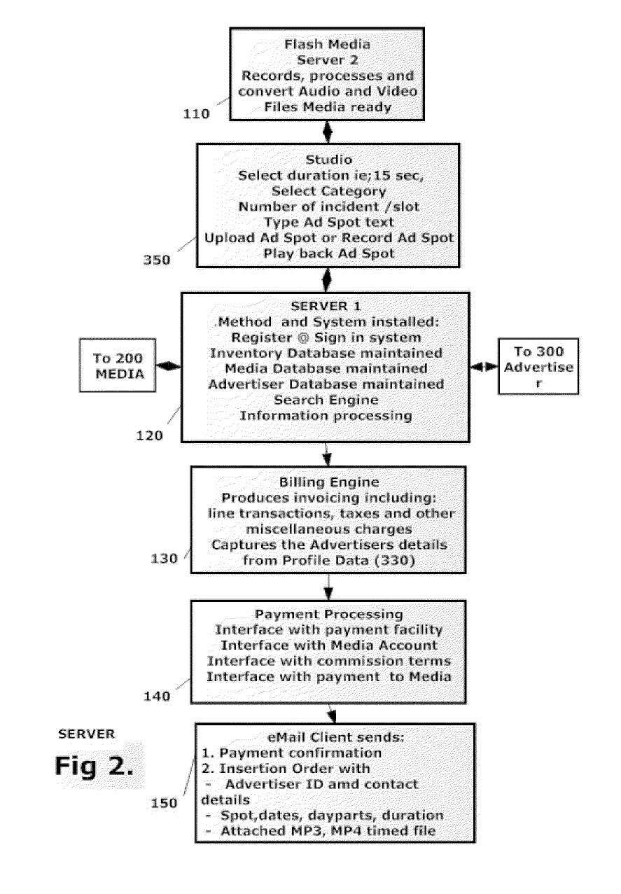

FIG. 2. Further shows the Server side process showing databases that contain registered Media customers, Advertising customers, inventory management, transaction records and search engine. 120. The access to the server across the network or internet by both the Media and the Advertisers is shown at 121 and 122.

The built in Studio records and processes timed ad spots or uploads prior recorded spots 350 and is linked to a Flash Media Server 110 which carries out the recording and processing of audio and video files. The billing Engine 130 on completion of recording or upload of files, produces a detailed invoice identifying the number of Spots, the cost of each spot and the broadcast dates of said Ad Spots, information on the Advertiser and other relevant information and hands off to the Payment processing engine 140 which manages the payment by Credit Card. On a successful financial transaction, the system will email the transaction details and sound or video files to the respective Media and copy the Advertiser 150

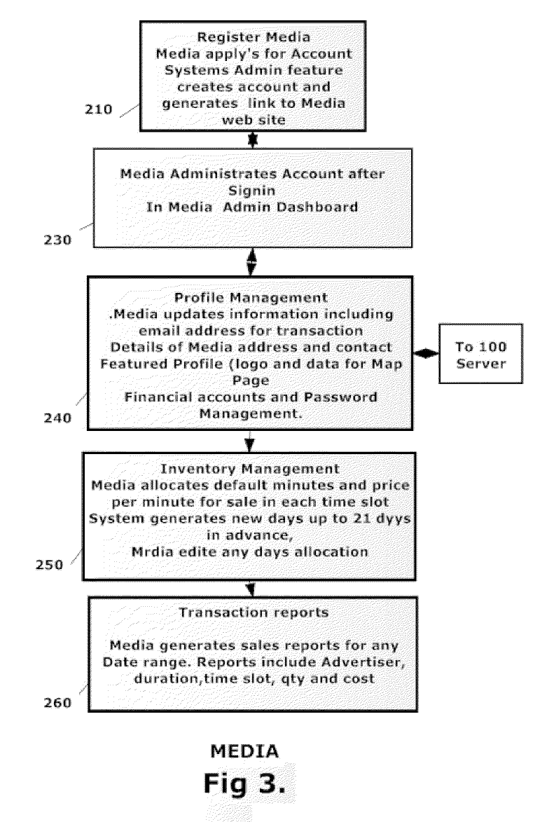

FIG. 3. Media interaction with the system is demonstrated here.

Using various paths, Media applies to participate and offer minutes for sale. The systems Admin feature creates an account and generates a link for the qualifying Media to strategically place on the Media's website. This link, when clicked on by a potential Advertiser in the Media's website, will direct the User to a special landing page where the user can register or sign in to purchase Ad Spots exclusively from the supplying Media. 210.

230 After signing in, the media is able to administrate its business on the System through its Admin Dashboard 230.

240 The Media is able to further manage its profile. Prior to sign in, the Ad User may drill down on the Google Map landing page to examine the profiles of Media in any geographic location. This information includes the identity of the Media, its email or other contact information, the Medias web address, its average cost per minute, and format. The Media is able to edit this information in their Profile Management 240.

250 The Media can manage its allocation of minutes for sale. Establish default quantity of minutes and default prices for minutes up to 21 days prior to broadcast date. The system will thence forth create new advance days of inventory at the default values. The Media can, at any time, for any date and day part, increase or reduce the default minutes and change prices for yet unsold inventory. 250

260 The Media enjoys the functionality of generating sales reports on the system which generates information including Advertiser, duration, date, time slot, quantity and revenue. 260

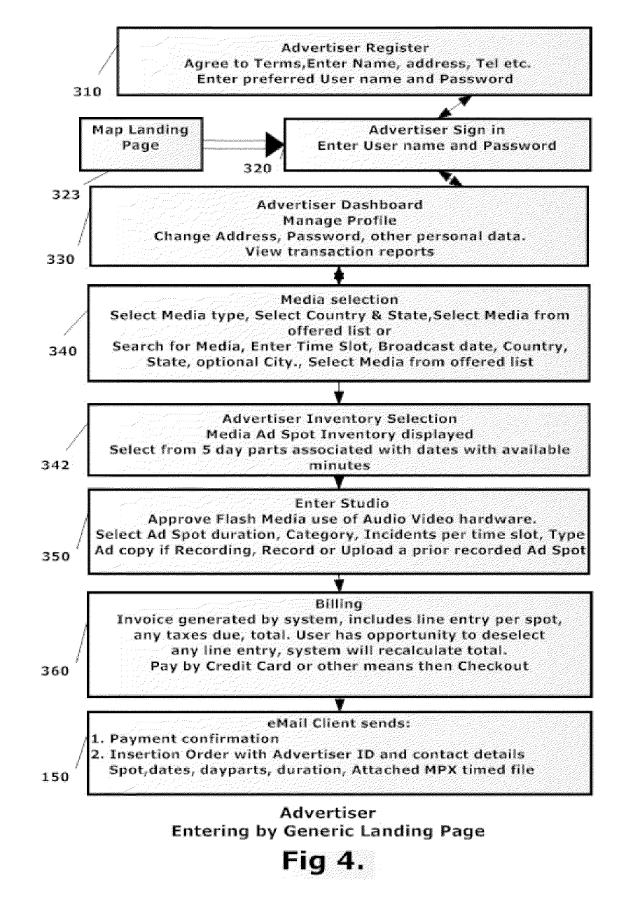

FIG. 4. Is a diagram of a part of the system showing the process and functionality enjoyed by the Advertising User. The Advertiser may arrive at a Sign in landing page either by entering the web address of the system or by a special account link on a participating Media's website. FIG. 4. describes the process for an Advertiser entering the site from the web address of the system called the Map Landing Page 323.

On arrival at the Map Landing Page 323 the Advertising User may sign in to an existing account 320 or in the alternative, select Register and create an account autonomously 310

On successful sign in to the Advertiser Dashboard, the Ad User is able to manage User information such as address, email address, telephone, password among other features. 330

Media Selection enables the Ad User to use search criteria such as Country and State as one method of finding Media. Alternatively, the Ad User may select search for ad Spot using a selection of criterion to filter the result such as, time slot, broadcast date, Country, State and City 340.

Having selected the preferred Media from the search results, the Ad User is able to select from the inventory of minutes available across 5 day parts and 21 days ahead. 342

After selection of Ad Spots the Ad User will be directed to the built in Studio 350 which records and processes timed ad spots or uploads prior recorded spots. This process is aided by a Flash Media Server FIG. 1. 110 which carries out the recording and processing of audio and video files.

The billing interface 360, on completion of recording or upload of files, produces a detailed invoice identifying the number of Spots, the cost of each spot and the broadcast dates of said Ad Spots, information on the Advertiser and other relevant information and hands off to the Payment processing module 360 which interfaces with the Paypal, Credit Card Processing engine on the Server 1. see FIG. 1. 140, which manages the payment by Credit Card. On a successful financial transaction, the system will email the transaction details and sound or video files to the respective Media and copy the Advertiser 150.

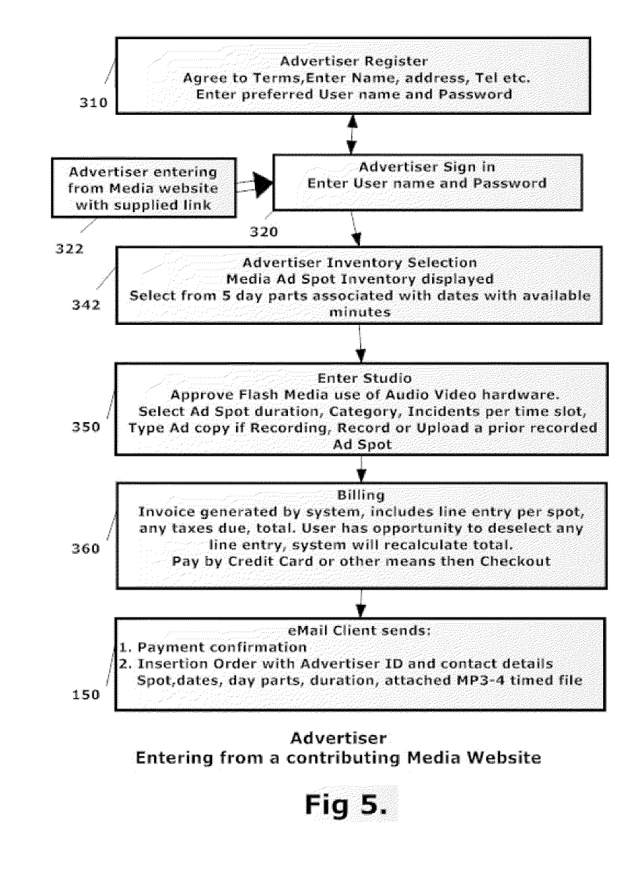

FIG. 5. Describes the Systems operation when an Ad User enters from the provided link on a participating Media's website 322.

As the supplying Media is the provider of this Ad User to the System, the only available Media to the User is the forwarding Media's account. Therefore, after Sign in 320, or Register 310, the Ad User is referred by the System to the supplying Media's account exclusively and bypasses the normal Media selection process and is shown the supplying Media's inventory for purchase. 342.

After selecting the required Ad Spots the Ad User is sent to the built in Studio 350 which records and processes timed ad spots or uploads prior recorded spots. This process is aided by a Flash Media Server FIG. 1. 110 which carries out the recording and processing of audio and video files. The billing interface 360, on completion of recording or upload of files, produces a detailed invoice identifying the number of Spots, the cost of each spot and the broadcast dates of said Ad Spots, information on the Advertiser and other relevant information and hands off to the Payment processing engine FIG. 1. 140 which manages the payment by Credit Card. On a successful financial transaction, the system will email the transaction details and sound or video files to the respective Media and copy the Advertiser 150.

FIG. 6. The System's Landing page is a Google Earth type geographical locator for the Media participating on the system.

Each active Media, with available minutes, is exhibited as a Green Radio Tower graphic. Media without available minutes for sale are exhibited as a Red Radio Tower

Additionally, prior to sign in, the Ad User may drill down on the Google Map landing page to examine the profiles of Media in any geographic location. This information becomes available when clicking on a Radio Tower graphic on the Map and includes the identity of the Media, its website address, its average cost per minute, broadcast frequency if any, call sign, City, and format. The world wide web address is an active link to the viewed media's website. See graphic image of an example of the process. 620.

What is claimed is:

1. A system and method installed on computer servers connected to the internet, maintains several Databases relating to advertising spots (Ad Spot) which are posted on the system by various electronic Media clients that offer audio or video Ad Spots for sale to Advertisers with an account, who select the quantity of minutes, broadcast dates and times, uploads a prerecorded Ad spot or uses the systems studio to record the timed Ad Spot, which is then converted by the system into file formats required for broadcast, then the system generates an invoice, collects payment through different methods including Credit Cards, then the System communicates the transaction details and audio/video file to the selected Media for broadcast and others by email and other means.

2. The system as defined in claim 1. further can be installed as an online or otherwise networked software.

3. The system as defined in claim 1. further has the capability of producing and recording timed audio and video ad spots with or without added music or sound effects and convert these created files to formats used by media to broadcast said recordings.

4. The system as defined in claim 3. further will access the built in or attached camera and microphone on the said devices for the production and recording of audio and video ad spots as well as play back Ad Spots recorded by Advertisers on their own computing or communications devices.

5. The system as defined in claim 1. further has the capability of producing an invoice with transaction details to include the duration of the Ad Spot, the dates and times of broadcast, the number of insertions per Day Part or other period, calculate the sub total, add any taxes or added cost, then total the invoice for payment.

6. The system as defined in claim 5. further will have the functionality of initiating the processing of a credit card or other instrument of payment, collect the funds into a holding account and transfer the agreed principal amount to the nominated account of the broadcasting client autonomously.

7. The system as defined in claim 1. further will produce a transaction report and insertion order and email this report with the Audio/video file attached to the Media client with copy to Advertiser and retained on the system for generating transaction reports.

8. The system as defined in claim 4. further will be able to query the Database of transactions and retrieve an Ad Spot searching by type of goods or service, broadcast date or Geographic location by any user through a suitable communication or computing device as previously specified, and upon retrieval, afford the ability to Play back the audio or video Ad spot through the system.

9. The system as defined in claim 1. further will create a coded link for each Media that will connect it's website to their Account on the system which will carry the potential Advertiser from the Media's site to the systems ad spot sales engine; such Users will be guided through the system to the completion of a sale as the exclusive customer of the supplying Media.

10. The system as defined in claim 9. to further afford the Advertising User the option to select from an inventory of minutes at prices per minute as allocated by the selected Media then to the date and day part for broadcast.

11. The system as defined in claim 10. to further offer the advertiser the options of choosing the Ad spot duration, the quantity of Ad spots per day part (time slot), the type of goods or service being advertised, of writing, producing and voicing an ad spot in the built in studio of the system or in the alternative, upload a prior recorded ad spot.

12. The system as defined in claim 11. to further produce an invoice, including any taxes and processing the credit card of the User to complete the transaction.

13. The system as defined in claim 12. to further produce an email with insertion order, the attached timed Ad spot copy in MP3 or other format broadcast ready, sent to the selected Media and copied to the Ad User

14. The system as defined in claim 13. to further maintain the data on the system in a database where the Ad spot can be retrieved and replayed by an interested visitor to the system.

15. The system as defined in claim 1. to further have the capability to be compiled into an executable file for installation on the servers of a Media Group where the system will manage the prior priced inventory of minutes for multiple Media in the group for purchase by Advertisers.

16. The system as defined in claim 1. to further have facility to generate a link to be placed on the participating Media's website, which when acted on my an advertiser, shall cause the Advertiser to become exposed exclusively to the offers of ad spots on the referring Media's account on the system through to completion of a transaction.
